(19) United States
(12) Patent Application Publication
(10) Pub. No.: US 2019/0384451 A1
(43) Pub. Date: Dec. 19, 2019

(54) POSITION SENSOR, POSITION SENSING METHOD, AND ASSOCIATED STATE-SWITCHING METHOD

(71) Applicant: TOUCHPLUS INFORMATION CORP., New Taipei City (TW)

(72) Inventor: Shih-Hsien HU, New Taipei City (TW)

(21) Appl. No.: 16/429,325

(22) Filed: Jun. 3, 2019

(30) Foreign Application Priority Data
Jun. 5, 2018 (TW) 107119348

(51) Int. Cl. G06F 3/044; G06F 3/041

(52) U.S. Cl. CPC G06F 3/0443; G06F 2203/04114; G06F 3/0416; G06F 3/0448

(57) ABSTRACT

A position-sensing device, a position-sensing method and an associated state-switching method are used with an object to be sensed, a first group of electrodes and a second group of electrodes. The position-sensing method includes: issuing a driving signal to the first group of electrodes; selecting at least first and second electrodes from the second group of electrodes, and performing an electric property measuring operation, wherein a plurality of floating electrodes exist between between the first and second electrodes, and the first and second electrodes respectively generate a capacitive coupling effect to the object and generate first and second electric values in response to the driving signal; and estimating a relative position of the object to the first electrode and to the second electrode according to the first and second electric values.

### FIELD OF THE INVENTION

The present invention relates to a position-sensing device and a related position-sensing method, and more particularly to a capacitive touch position-sensing device and a related capacitive touch position-sensing method for underwater applications.

### BACKGROUND OF THE INVENTION

Capacitive touch panels have been widely used in various electronic information devices, principally for implementing a human-machine input interface on a device. In practical uses, in contrast with a resistive touch panel, a capacitive touch panel requires a less intensive pressing force and does need to make conductive layers actually contact with each other, so it is advantageous in less readily aging and wearing. More preferably, a capacitive touch panel reacts much faster than a resistive touch panel, and can easily sense a touch or slide operation of a user's finger or other conductive object (such as a stylus). However, in commonly used capacitive touch sensing methods, when a touch panel is used with overlying water drops or even under water, the conventional capacitive touch panel cannot operate normally since either freshwater or sea water can be regarded as a conductor. Objects of the present invention are to develop a capacitive touch sensing panel that can operate normally in a humid environment or even in an underwater environment, and to develop an associated sensing method ameliorating the defects of conventional means.

### SUMMARY OF THE INVENTION

For overcoming the drawbacks of the above-described conventional capacitive touch sensing techniques, the present invention provides a position-sensing method for use with an object to be sensed, a first group of electrodes and a second group of electrodes. The position-sensing method includes steps of: issuing a driving signal to the first group of electrodes; selecting at least a first electrode and a second electrode from the second group of electrodes, and performing an electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and estimating a relative position of the object to be sensed to the first electrode and to the second electrode according to the first electric value and the second electric value generated in the electric property measuring operation.

Based on the above concept, in a position-sensing method according to the present invention, the first group of electrodes and the second group of electrodes are formed on a sensing panel, the first group of electrodes extend in a first direction. The second group of electrodes extend in a second direction and cross over the first group of electrodes within the sensing panel. The method further includes steps of: issuing a driving signal to the second group of electrodes; selecting at least a third electrode and a fourth electrode from the first group of electrodes, and performing an electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and estimating a relative position of the object to be sensed to the third electrode and to the fourth electrode according to the third electric value and the fourth electric value generated in the electric property measuring operation.

Based on the above concept, in a position-sensing method according to the present invention, the second group of electrodes are formed on a sensing panel. The second group of electrodes cross over the first group of electrodes outside the sensing panel. The second group of electrodes are allocated as an array on the sensing panel and essentially formed of the same single electrode layer, and have a shape of square or regular hexagon.

Based on the above concept, in a position-sensing method according to the present invention, the electric value is either a voltage value or a capacitance value, and the driving signal is a driving voltage signal.

Another aspect of the present invention relates to a position-sensing device for sensing a position of an object to be sensed. The position-sensing device includes: a first group of electrodes; a second group of electrodes crossing over the first group of electrodes; and a control circuit coupled to the first group of electrodes and the second group of electrodes, wherein the control circuit issues a driving signal to the first group of electrodes, selects at least a first electrode and a second electrode from the second group of electrodes, and performs an electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and the control circuit estimates a relative position of the object to be sensed to the first electrode and to the second electrode according to the first electric value and the second electric value generated in the electric property measuring operation.

Based on the above concept, in a position-sensing device according to the present invention, the first group of electrodes and the second group of electrodes are formed on a sensing panel, the second group of electrodes cross over the first group of electrodes within the sensing panel, and the control circuit further executes steps of: issuing a driving signal to the second group of electrodes; selecting at least a third electrode and a fourth electrode from the first group of electrodes, and performing an electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and estimating a relative position of the object to be sensed to the third electrode and to the fourth electrode according to the third electric value and the fourth electric value generated in the electric property measuring operation.

Based on the above concept, in a position-sensing device according to the present invention, the second group of electrodes are formed on a sensing panel and allocated as an array on the sensing panel, and the second group of electrodes cross over the first group of electrodes outside the sensing panel, essentially formed of the same single electrode layer, and having a shape of square or regular hexagon.

Based on the above concept, in a position-sensing device according to the present invention, the electric value is either a voltage value or a capacitance value, and the driving signal is a driving voltage signal.

Based on the above concept, in a position-sensing device according to the present invention, the second group of electrodes are formed on a sensing panel and allocated as a network on the sensing panel, and the second group of electrodes cross over the first group of electrodes outside the sensing panel.

A further aspect of the present invention relates to a position-sensing device for sensing a position of an object to be sensed. The position-sensing device includes: a first group of electrodes; a first driving electrode crossing over and capacitive coupling to the first group of electrodes; a second group of electrodes crossing over the first group of electrodes; and a control circuit issuing a driving signal by way of a capacitive coupling of the first driving electrode to the first group of electrodes, selecting at least a first electrode and a second electrode from the second group of electrodes, and performing an electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and the control circuit estimates a relative position of the object to be sensed to the first electrode and to the second electrode according to the first electric value and the second electric value generated in the electric property measuring operation.

Based on the above concept, in a position-sensing device according to the present invention, the first group of electrodes and the second group of electrodes are formed on a sensing panel. The second group of electrodes cross over the first group of electrodes within the sensing panel. The first driving electrode crosses over the first group of electrodes outside the sensing panel. A second driving electrode crosses over the second group of electrodes outside the sensing panel. The control circuit further executes steps of: issuing a driving signal by way of a capacitive coupling of the second driving electrode to the second group of electrodes; selecting at least a third electrode and a fourth electrode from the first group of electrodes, and performing an electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and estimating a relative position of the object to be sensed to the third electrode and to the fourth electrode according to the third electric value and the fourth electric value generated in the electric property measuring operation.

Based on the above concept, in a position-sensing device according to the present invention, the electric value is either a voltage value or a capacitance value, and the driving signal is a driving voltage signal.

Still another aspect of the present invention relates to a state-switching method. The state-switching method includes steps of: executing the position-sensing method as recited in claim 1 at intervals, and determining whether a touch action occurs in a first state; switching the first state into a second state when it is determined that the touch action occurs, and continuing to execute the position-sensing method as recited in claim 1; and switching the second state back into the first state if no touch action has been sensed in the second state for a certain period of time.

For better understanding of the above and other aspects of the present invention, embodiments are exemplified and described as follows with reference to accompanying drawings described in detail below:

### BRIEF DESCRIPTION OF THE DRAWINGS

FIG. 1a is a schematic diagram illustrating a position-sensing device developed according to the present invention;

FIG. 1b is a cross-sectional view schematically illustrating a portion of a position-sensing device developed according to the present invention;

FIG. 2 is a flowchart of a position-sensing method developed according to the present invention;

FIG. 3 is a schematic diagram illustrating a waveform of voltages measured at two sensing electrode rows according to an embodiment of the present invention;

FIG. 4 is a schematic diagram illustrating another capacitive sensing panel that uses a sensing method according to the present invention;

FIG. 5 is a schematic diagram illustrating a further capacitive sensing panel that uses a sensing method according to the present invention; and

FIG. 6 is a flowchart schematically illustrating a sensing-state switching method developed according to the present invention.

### DETAILED DESCRIPTION OF PREFERRED EMBODIMENTS

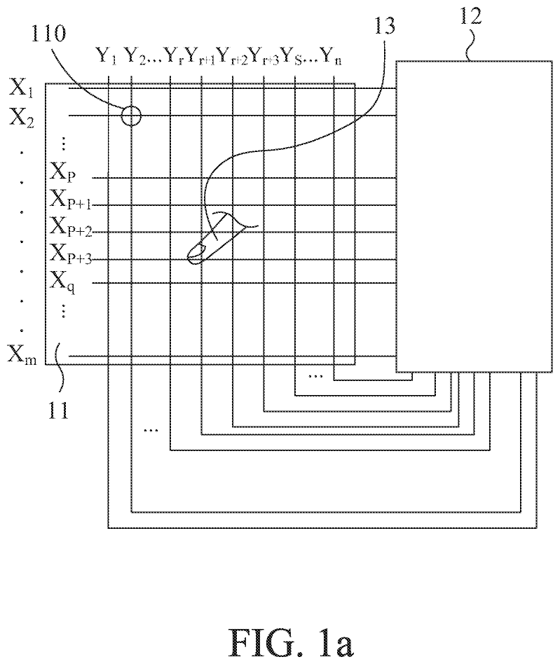

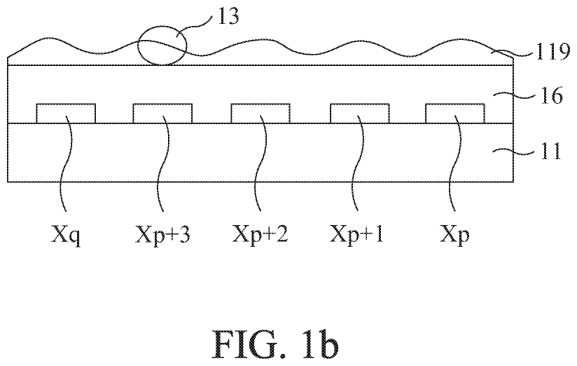

Please refer to FIG. 1a, which is a schematic diagram illustrating a position sensing device developed in the present invention. The positioning sensing device mainly includes a sensing panel 11 and a control circuit 12. In this embodiment, the sensing panel 11 is implemented with a common two-dimensional layout, which includes a set of m electrodes X1, X2, . . . Xm extending in a first direction (a horizontal direction as shown in the figure) and a set of n electrodes Y1, Y2, . . . , Yn extending in a second direction (a vertical direction as shown in the figure). The electrodes X1, X2, . . . , Xm and the electrodes Y1, Y2, . . . , Yn are generally spaced with an insulating material (not shown) at crossing-over intersections 110 so as to form capacitor structures. Furthermore, a protective cover (not shown) is usually provided between the capacitive sensing panel 11 and the user's finger (or another conductive sensed object, such as a stylus).

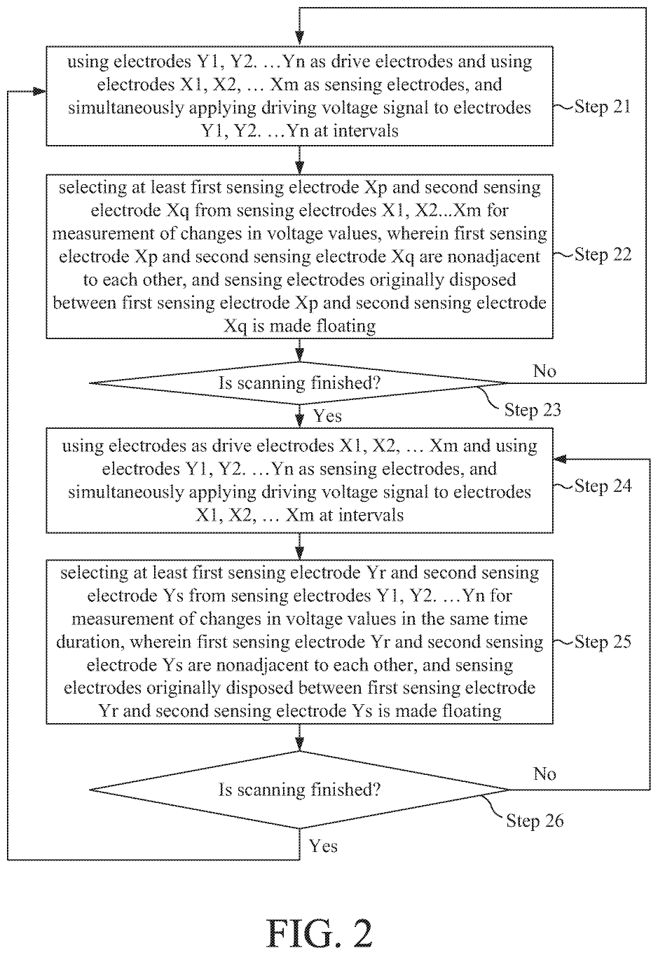

In order to maintain the capacitive touch sensing function under water, a control circuit 12 of the present invention performs a sensing method as illustrated in a flow chart of FIG. 2 on the sensing panel 11. First, in Step 21, the electrodes Y1, Y2 . . . Yn are used as driving electrodes, and the electrodes X1, X2 . . . Xm are used as sensing electrodes. A driving voltage signal (for example, a charging signal rising from a low voltage level to a high voltage level) is simultaneously emitted to the electrodes Y1, Y2, . . . , Yn at intervals. Capacitive structures (e.g., 110 shown in the figure) are formed at crossing-over intersections between the electrodes X1, X2 . . . Xm and the electrodes Y1, Y2 . . . Yn, so as to render a capacitive coupling effect. In Step 22, the control circuit 12 selects at least a first sensing electrode Xp and a second sensing electrode Xq from the set of sensing electrodes X1, X2, . . . Xm for voltage change measurement. It should be noted that the first sensing electrode Xp is not adjacent to the second sensing electrode Xq, and a distance therebetween is enlarged to a level greater than a width of the finger (or another conductive sensed object). The sensing electrodes (for example, Xp+1, Xp+2 and Xp+3 in the figure) originally disposed between the first sensing electrode Xp and the second sensing electrode Xq is made floating by the control circuit 12. Preferably, all the electrodes except the first sensing electrode Xp and the second sensing electrode Xq to be measured are made floating by the control circuit 12.

In this way, when the surface of the capacitive sensing panel 11 is covered with a conductive liquid such as water or seawater (as illustrated in the cross-sectional view of FIG. 1b), and the sensed object (in this example, the finger 13) is placed at the position as specified in the figure, the floating sensing electrodes Xp+1, Xp+2, Xp+3 between the first sensing electrode Xp and the second sensing electrode Xq will constitute a floating conductive layer together with the moisture 119 on the surface (also regarded as a floating conductor). The floating conductive layer extends at least from the first sensing electrode Xp to the second sensing electrode Xq. Therefore, a capacitive coupling effect between the finger 13 and each of the first sensing electrode Xp and the second sensing electrode Xq is generated through the floating conductor layer, thereby changing the equivalent capacitance that can be measured from the first sensing electrode Xp and the second sensing electrode Xq. Since the fingers 13 is respectively coupled to the first sensing electrode Xp and the second sensing electrode Xq through the floating conductor layer from difference distances, different charging/discharging behaviors can be respectively measured at the first sensing electrode Xp and the second sensing electrode Xq in response to the driving signal. Based on the different charging/discharging behaviors, the first electrical value and the second electrical value belonging to the first sensing electrode Xp and the second sensing electrode Xq, respectively, can be determined, or the difference between the electrical values, e.g. a first voltage value and a second voltage value or a voltage difference, or a first capacitance value, a second capacitance value, and a capacitance difference value, can be directly realized.

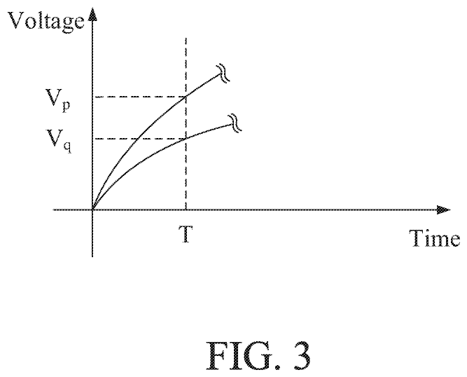

For example, when the driving voltage signal is a charging signal from a low voltage to a high voltage, the charging signal is coupled to the first sensing electrode Xp and the second sensing electrode Xq, respectively, by way of the crossing-over intersections between the electrodes Y1, Y2, . . . , Yn and each of the first sensing electrode Xp and the second sensing electrode Xq, so as to result in different charging and discharging behaviors of the first sensing electrode Xp and the second sensing electrode Xq which have different equivalent capacitance values. In this example, the position of the finger 13 is closer to the second sensing electrode Xq than to the first sensing electrode Xp, so the equivalent capacitance between the second sensing electrode Xq and the finger 13, which are coupled through the floating conductor layer, is larger, while the equivalent capacitance between the first sensing electrode Xp and the finger 13, which are coupled through the floating conductor layer, is smaller. Under the same driving voltage signal, the first voltage value on the first sensing electrode Xp will rise above the second voltage value on the second sensing electrode Xq in the same unit time. Therefore, it can be seen from the waveform diagram of FIG. 3 that the distance relationships between the finger 13 and each of the first sensing electrode Xp and the second sensing electrode Xq can be determined according to the magnitude relationships between the voltages Vp and Vq measured at the first sensing electrode Xp and the second sensing electrode Xq at the time point T. As exemplified in FIG. 1, if the finger 13 is located at the floating sensing electrode Xp+2, the voltages Vp and Vq respectively measured at the first sensing electrode Xp and the second sensing electrode Xq at the time point T are supposed to be equal. The distances between the finger 13 and each of the first sensing electrode Xp and the second sensing electrode Xq would be determined to be equal. If the finger 13 is located at the floating sensing electrode Xp+1, the difference (Vp−Vq) between the two voltages Vp and Vq respectively measured at the first sensing electrode Xp and the second sensing electrode Xq at the time point T would be a negative value, which indicates that the finger 13 is closer to the first sensing electrode Xp. If the finger 13 is located at the floating sensing electrode Xp+3, the difference between the two voltages Vp and Vq (i.e. Vp−Vq) respectively measured at the time point T on the first sensing electrode Xp and the second sensing electrode Xq would be a positive value (as shown in the example of FIG. 1 and corresponding to the example of FIG. 3), which indicates that the finger 13 is closer to the second sensing electrode Xq.

Then, repeat the sensing operations of Steps 21 and 22 above to select two separate ones of the sensing electrodes in turn to measure a change in voltage values for performing scanning in the second direction, i.e. the vertical direction as shown in the figure. In this way, up-down scanning can be performed on pairs of sensing electrodes along with three floating sensing electrodes disposed therebetween to locate the finger 13 in the second direction (i.e. the vertical direction in the figure). After it is determined that scanning is finished (Step 23), the process proceeds to Step 24. In order to locate the finger 13 in the first direction (i.e. the horizontal direction in the figure), the control circuit 12 then proceeds to Step 24, wherein the electrodes X1, X2, . . . Xm are used as the drive electrodes and the electrodes Y1, Y2 . . . Yn are used as the sensing electrodes. A driving voltage signal (for example, a charging signal from a low voltage to a high voltage) is simultaneously applied to the electrodes X1, X2, . . . Xm at intervals. Capacitive structures (e.g., 110 shown in the figure) are formed at crossing-over intersections between the electrodes X1, X2 . . . Xm and the electrodes Y1, Y2 . . . Yn, so as to render a capacitive coupling effect. In Step 25, the control circuit 12 selects at least a first sensing electrode Yr and a second sensing electrode Ys, which are disposed with a plurality of floating sensing electrodes (Yr+1, Yr+2 and Yr+3 in the example of FIG. 1), from the set of sensing electrodes Y1, Y2 . . . Yn for voltage change measurement. Then, repeat the sensing operations of Steps 24 and 25 above to select two separate ones of the sensing electrodes in turn to measure a change in voltage values for performing scanning in the first direction, i.e. the horizontal direction as shown in the figure. In this way, up-down scanning can be performed on pairs of sensing electrodes along with three floating sensing electrodes disposed therebetween to locate the finger 13 in the first direction (i.e. the horizontal direction in the figure) until it is determined that scanning is finished (Step 26), and the position of the finger 13 in the first direction (i.e. the horizontal direction in the figure) is located. (In this example, the finger 13 is disposed at the electrode Yr+1, which is closer to the first sensing electrode Yr).

After synthesizing the positions in the first direction (the horizontal direction in the figure) and the second direction (the vertical direction in the figure) realized in the above steps, the position of the finger 13 on the panel can be located. Taking this figure as an example, it can be found that the finger 13 is located at the intersection of the electrode Yr+1 and the electrode Xp+3. The capacitive sensing panel in the above example is a two-dimensional sensing panel. Therefore, the driving electrodes and the sensing electrodes need to be alternately changed to determine coordinate positions in both axes, respectively. If the capacitive sensing panel in another example is a one-dimensional sensing panel, e.g. with a strip-shaped sensing region, then it is necessary to scan only in one axis to locate the coordinate position.

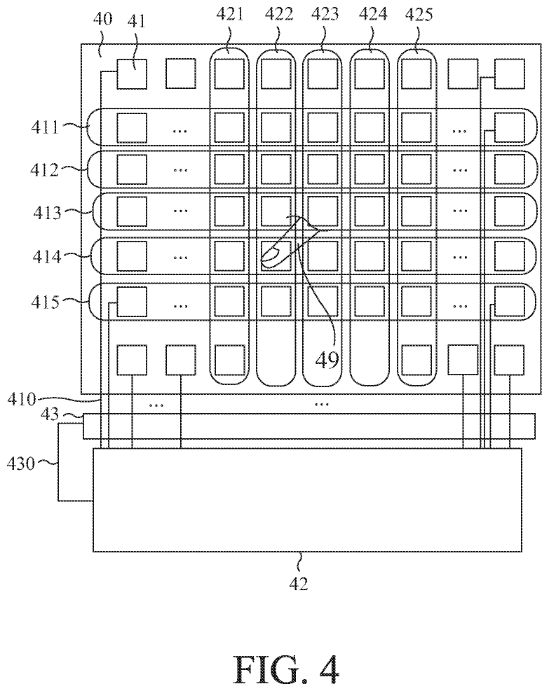

Referring further to FIG. 4, which is a schematic diagram of another capacitive sensing panel that the sensing method according to the present invention can be used with. The sensing panel as shown is characterized in that the crossing-over intersections of the electrodes thereof (for example, the ones as indicated with the numeral reference 110 shown in FIG. 1) are disposed outside the panel instead of inside the panel. Therefore, the sensing electrodes 41 allocated as an array in the sensing panel 40 may be formed in a single electrode layer, each having a shape of square, regular hexagon or any other shape that can be allocated densely. Compared to the embodiment of FIG. 1, which is implemented with a structure of multi-layers spaced with an insulating material at the crossing-over intersections, the embodiment as shown in this figure can be accomplished with a simpler single electrode layer. Signal connection lines 410 respectively extending from the sensing electrodes 41 (not entirely shown with associated electrodes in the figure and partially omitted for neat drawing) can be electrically connected to a control circuit 42, which is implemented with an IC chip, through a flexible circuit board or by way of other electrical contact means. The control circuit 42 is electrically connected to the driving electrodes 43 through driving signal lines 430. The driving electrodes 43 and the signal connecting lines 410 form crossing-over intersections of electrodes outside the panel 40 (i.e. the driving electrodes 43 cross over the signal connecting lines 410 and insulating material is disposed therebetween) so as to conduct capacitive coupling. A driving signal issued by the control circuit 42 to a driving electrode 43 through a driving signal line 430 (for example, a charging signal from a low voltage to a high voltage) is capacitively coupled and transferred to a signal connection line 410 through the electrode crossover, thereby in turn affecting the sensing electrode 41 to which the signal connection line 410 is connected. In the embodiment as illustrated in this figure, an extensive piece of driving electrode 43 is used to drive all of the signal connecting lines 410 at the same time. Of course, the plurality of signal connecting lines 410 may be divided into a plurality of groups, and a plurality of corresponding driving signal lines may be used with a plurality of separate driving electrodes for respective driving. Reference of related art may be made to the contents of the specification of a Taiwanese patent application (Taiwanese Patent No. 1467458, Chinese Patent No. CN103677467, and U.S. Pat. No. 9,240,078).

With the sensing panel shown in FIG. 4, the steps described in the flowchart of FIG. 2 can still be used to perform underwater touch sensing. The details are detailed as follows. Similar to Step 21, a driving voltage signal, e.g. a charging signal rising from a low voltage level to a high voltage level, is issued to the driving electrodes 43 at intervals. Thus, a capacitive coupling effect would be generated at the crossing-over intersections between the sensing electrodes 41 and the signal connection lines 410, where capacitor structures are formed, so as to result in capacitance changes of the sensing electrodes 41. In Step 22, the control circuit 42 selects at least two rows of sensing electrodes, which are non-adjacent and separated distantly enough from each other, from the group of sensing electrodes 41 (for example, the row of electrodes 411 and the row of electrodes 415 circled in the figure). At the same duration, measurement of changes in voltage values is conducted. The purpose is to have a spacing between the two sensing electrode rows exceed the width of the finger (or another conductive object to be sensed) 49. The other rows of sensing electrodes originally disposed between the two sensing electrode rows (for example, the rows of electrodes 412, 413 and 414 circled in the figure) are made to be in a floating state by the control circuit 42 to constitute a floating conductive layer together with the moisture on the surface of the panel 40, which can also be considered as a floating conductor. Preferably, all the other rows of sensing electrodes except the two sensing electrode rows to be measured are set to be floating by the control circuit 42. Take FIG. 4, in which the finger 49 is located at the floating sensing electrode row 413, as an example. The voltages measured by the control circuit 42 respectively at the sensing electrode row 411 and the sensing electrode row 415 would be equal, which shows that the distances from the finger 49 to the sensing electrode row 411 and the sensing electrode row 415 are equal. In a case that the finger 49 is located at the floating sensing electrode row 412, a difference between the two voltages measured by the control circuit 42 at the sensing electrode row 411 and the sensing electrode row 415 would be a negative value, which shows that the finger 49 is closer to the sensing electrode row 411. In another case that the finger 49 is located at the floating sensing electrode row 414, a difference between the two voltages measured by the control circuit 42 at the sensing electrode row 411 and the sensing electrode row 415 would be a positive value, as shown in FIG. 4, which shows that the finger 49 is closer to the sensing electrode row 415.

In this way, the sensing operations of Steps 21 and 22 are repeated, and two spaced-apart rows of sensing electrodes are selected in turn to measure changes in voltage values for scanning in the second direction (the vertical direction in the figure). The two spaced-apart rows of sensing electrodes sandwiching three rows of floating sensing electrodes are moved in an up-down direction to scan, thereby locating the position of the finger 49 in the second direction (the vertical direction of the figure) until it is determined that scanning has been completed (Step 23). Subsequently, the process proceeds to Step 24. In order to locate the finger 49 in the first direction (the horizontal direction in the figure), the control circuit 42 executes Step 24 with the vertically allocated sensing electrode rows serving as the sensing electrodes, and issues a driving voltage signal (for example, a charging signal from a low voltage to a high voltage) to the drive electrode 43 at intervals in a similar manner. Thus, a capacitive coupling effect would be generated at the crossing-over intersections between the sensing electrodes 41 and the signal connection lines 410, where capacitor structures are formed, so as to result in capacitance changes of the sensing electrodes 41. In Step 25, the control circuit 42 simultaneously selects at least two rows of sensing electrodes, which are non-adjacent and separated distantly enough from each other, from the group of sensing electrodes 41 (for example, the row of electrodes 421 and the row of electrodes 425 circled in the figure). Meanwhile, measurement of changes in voltage values is conducted. The purpose is to have a spacing between the two sensing electrode rows exceed the width of the finger (or another conductive object to be sensed) 49. The other rows of sensing electrodes originally disposed between the two sensing electrode rows (for example, the rows of electrodes 422, 423 and 424 circled in the figure) are made to be in a floating state by the control circuit 42 to constitute a floating conductive layer together with the moisture on the surface of the panel 40, which can also be considered as a floating conductor. Preferably, all the other rows of sensing electrodes except the two sensing electrode rows to be measured are set to be floating by the control circuit 42. Take FIG. 4, in which the finger 49 is located at the floating sensing electrode row 423, as an example. The voltages measured by the control circuit 42 respectively at the sensing electrode row 421 and the sensing electrode row 425 would be equal, which shows that the distances from the finger 49 to the sensing electrode row 421 and the sensing electrode row 425 are equal. In a case that the finger 49 is located at the floating sensing electrode row 412, a difference between the two voltages measured by the control circuit 42 at the sensing electrode row 421 and the sensing electrode row 425 would be a negative value, which shows that the finger 49 is closer to the sensing electrode row 421. In another case that the finger 49 is located at the floating sensing electrode row 424, a difference between the two voltages measured by the control circuit 42 at the sensing electrode row 421 and the sensing electrode row 425 would be a positive value, as shown in FIG. 4, which shows that the finger 49 is closer to the sensing electrode row 425.

After synthesizing the positions in the first direction (the horizontal direction in the figure) and the second direction (the vertical direction in the figure) realized in the above steps, the position of the finger 49 on the panel can be located. Taking this figure as an example, it can be found that the finger 49 is located at the intersection of the electrode row 414 and the electrode row 422. The capacitive sensing panel in the above example is a single-layer multi-points sensing panel. Alternatively, the above-mentioned sensing electrode rows may also be implemented with only a single sensing electrode 41, or with a group of electrodes having various aspects, e.g. 2*1, 3*1 or 3*3 for sensing according to requirements. The variations and control of the group are all conducted by the control circuit 42. If the capacitive sensing panel is exemplified to be a single axial sensing panel, then only one axial scanning is required to complete the positioning.

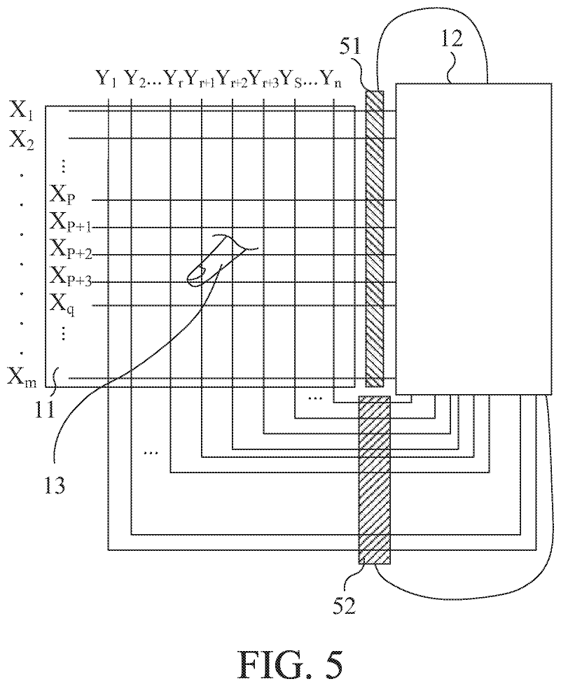

Referring again to FIG. 5, which is a schematic diagram of still another capacitive sensing panel that can use the sensing method of the present invention. It is characterized in that the driving electrode in FIG. 1 is adjusted so that the driving signal is not directly issued to the electrodes on the sensing panel 11 by the control circuit 12, but instead, the driving signal is coupled to the electrodes X1, X2 . . . Xm and the electrodes Y1, Y2 . . . Yn through a capacitive coupling effect. The capacitive coupling effect results from the capacitor structures formed outside the sensing panel 11 by crossing the driving electrodes 51 and 52 outside the sensing panel 11 over the electrodes X1, X2 . . . Xm and the electrodes Y1, Y2 . . . Yn. Furthermore, in this example, the electrodes X1, X2, . . . , Xm and the electrodes Y1, Y2, . . . , Yn on the sensing panel 11 are allocated as a network, but the capacitance at the crossing over intersections of the electrodes X1, X2, . . . , Xm and the electrodes Y1, Y2, . . . , Yn within the area of the sensing panel 11 are not cared and would not be measured.

For example, the sensing method as illustrated in the flowchart of FIG. 2 is first executed. First, as in Step 21, the electrodes X1, X2 . . . Xm are used as sensing electrodes. A driving voltage signal (for example, a charging signal rising from a low voltage level to a high voltage level) is issued to the driving electrode 51 at intervals. Thus, a capacitive coupling effect would be generated at the crossing-over intersections between the electrodes X1, X2 . . . Xm and the sensing electrode 51, where capacitor structures are formed, so as to result in capacitance changes of the electrodes X1, X2 . . . Xm. At the same duration, in Step 22, the control circuit 12 selects at least a first sensing electrode Xp and a second sensing electrode Xq from the group of sensing electrodes X1, X2 . . . Xm for measurement of changes in voltage values. It is to be noted that the first sensing electrode Xp and the second sensing electrode Xq are non-adjacent to each other, and the purpose is to have a spacing between the the first sensing electrode Xp and the second sensing electrode Xq exceed the width of the finger (or another conductive object to be sensed). The sensing electrodes (for example, Xp+1, Xp+2 and Xp+3 in the figure) originally disposed between the first sensing electrode Xp and the second sensing electrode Xq is made floating by the control circuit 12. Preferably, all the electrodes except the first sensing electrode Xp and the second sensing electrode Xq to be measured are made floating by the control circuit 12.

In this way, when the surface of the capacitive sensing panel 11 is covered with a conductive liquid such as water or seawater (as illustrated in the cross-sectional view of FIG. 1b), and the sensed object (in this example, the finger 13) is placed at the position as specified in the figure, the floating sensing electrodes Xp+1, Xp+2, Xp+3 between the first sensing electrode Xp and the second sensing electrode Xq will constitute a floating conductive layer together with the moisture 119 on the surface (also regarded as a floating conductor). The floating conductive layer extends at least from the first sensing electrode Xp to the second sensing electrode Xq. Therefore, a capacitive coupling effect between the finger 13 and each of the first sensing electrode Xp and the second sensing electrode Xq is generated through the floating conductor layer, thereby changing the equivalent capacitance that can be measured from the first sensing electrode Xp and the second sensing electrode Xq. Since the fingers 13 is respectively coupled to the first sensing electrode Xp and the second sensing electrode Xq through the floating conductor layer from difference distances, different charging/discharging behaviors can be respectively measured at the first sensing electrode Xp and the second sensing electrode Xq in response to the driving signal. Based on the different charging/discharging behaviors, the first electrical value and the second electrical value belonging to the first sensing electrode Xp and the second sensing electrode Xq, respectively, can be determined, or the difference between the electrical values, e.g. a first voltage value and a second voltage value or a voltage difference, or a first capacitance value, a second capacitance value, and a capacitance difference value, can be directly realized.

For example, when the driving voltage signal is a charging signal from a low voltage to a high voltage, the charging signal is coupled to the first sensing electrode Xp and the second sensing electrode Xq, respectively, by way of the crossing-over intersections between the driving electrode 51 and each of the first sensing electrode Xp and the second sensing electrode Xq, so as to result in different charging and discharging behaviors of the first sensing electrode Xp and the second sensing electrode Xq which have different equivalent capacitance values. In this example, the position of the finger 13 is closer to the second sensing electrode Xq than to the first sensing electrode Xp, so the equivalent capacitance between the second sensing electrode Xq and the finger 13, which are coupled through the floating conductor layer, is larger, while the equivalent capacitance between the first sensing electrode Xp and the finger 13, which are coupled through the floating conductor layer, is smaller. Under the same driving voltage signal, the first voltage value on the first sensing electrode Xp will rise above the second voltage value on the second sensing electrode Xq in the same unit time. Therefore, it can be seen from the waveform diagram of FIG. 3 that the distance relationships between the finger 13 and each of the first sensing electrode Xp and the second sensing electrode Xq can be determined according to the magnitude relationships between the voltages Vp and Vq measured at the first sensing electrode Xp and the second sensing electrode Xq at the time point T. As exemplified in FIG. 5, if the finger 13 is located at the floating sensing electrode Xp+2, the voltages Vp and Vq respectively measured at the first sensing electrode Xp and the second sensing electrode Xq at the time point T are supposed to be equal. The distances between the finger 13 and each of the first sensing electrode Xp and the second sensing electrode Xq would be determined to be equal. If the finger 13 is located at the floating sensing electrode Xp+1, the difference (Vp−Vq) between the two voltages Vp and Vq respectively measured at the first sensing electrode Xp and the second sensing electrode Xq at the time point T would be a negative value, which indicates that the finger 13 is closer to the first sensing electrode Xp. If the finger 13 is located at the floating sensing electrode Xp+3, the difference between the two voltages Vp and Vq (i.e. Vp−Vq) respectively measured at the time point T on the first sensing electrode Xp and the second sensing electrode Xq would be a positive value (as shown in the example of FIG. 5 and corresponding to the example of FIG. 3), which indicates that the finger 13 is closer to the second sensing electrode Xq.

In this way, repeat the sensing operations of Steps 21 and 22 above to select two separate ones of the sensing electrodes in turn to measure a change in voltage values for performing scanning in the second direction, i.e. the vertical direction as shown in the figure. In this way, up-down scanning can be performed on pairs of sensing electrodes along with three floating sensing electrodes disposed therebetween to locate the finger 13 in the second direction (i.e. the vertical direction in the figure). After it is determined that scanning is finished (Step 23), the process proceeds to Step 24. In order to locate the finger 13 in the first direction (i.e. the horizontal direction in the figure), the control circuit 12 then proceeds to Step 24. A driving voltage signal (for example, a charging signal from a low voltage to a high voltage) is applied to the driving electrode 52 at intervals. Capacitive structures are formed at crossing-over intersections between the electrodes Y1, Y2 . . . Yn and the driving electrode 52, so as to render a capacitive coupling effect. At the same time duration, in Step 25, the control circuit 12 selects at least a first sensing electrode Yr and a second sensing electrode Ys, which are disposed with a plurality of floating sensing electrodes (Yr+1, Yr+2 and Yr+3 in the example of FIG. 5), from the set of sensing electrodes Y1, Y2 . . . Yn for voltage change measurement. Then, repeat the sensing operations of Steps 24 and 25 above to select two separate ones of the sensing electrodes in turn to measure changes in voltage values for performing scanning in the first direction, i.e. the horizontal direction as shown in the figure. In this way, left-right scanning can be performed on pairs of sensing electrodes along with three floating sensing electrodes disposed therebetween to locate the finger 13 in the first direction (i.e. the horizontal direction in the figure) until it is determined that scanning is finished (Step 26), and the position of the finger 13 in the first direction (i.e. the horizontal direction in the figure) is located. (In this example, the finger 13 is disposed at the electrode Yr+1, which is closer to the first sensing electrode Yr).

After synthesizing the positions in the first direction (the horizontal direction in the figure) and the second direction (the vertical direction in the figure) realized in the above steps, the position of the finger 13 on the panel can be located. Taking this figure as an example, it can be found that the finger 13 is located at the intersection of the electrode Yr+1 and the electrode Xp+3. The capacitive sensing panel in the above example is a two-dimensional sensing panel. Therefore, the driving electrodes and the sensing electrodes need to be alternately changed to determine coordinate positions in both axes, respectively. If the capacitive sensing panel in another example is a one-dimensional sensing panel, e.g. with a strip-shaped sensing region, then it is necessary to scan only in one axis to locate the coordinate position.

Driving the electrodes X1, X2 . . . Xm and the electrodes Y1, Y2 . . . Yn with driving signals in a capacitive coupling way would improve the performance of the floating electrode layer, as well as the sensing performance, since the electric field distribution of the floating electrode layer would not be directly affected by the driving signal. The driving electrodes 51 and 52 disposed outside the panel may also be integrated in the package of the control circuit 12.

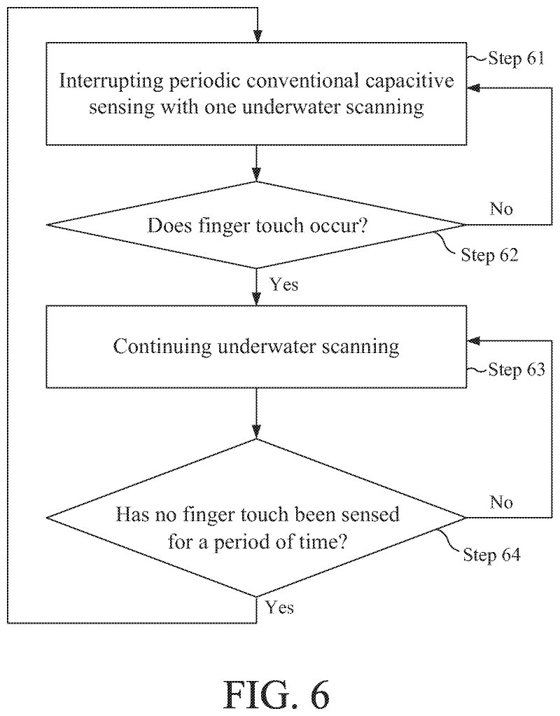

With the use of the sensing method proposed in the present invention, the above-described three sensing panels can effectively overcome the interference problems caused by conductive liquid on capacitive touch sensing, thereby achieving the objective of capacitive touch sensing under water. The above-described techniques facilitate normal operations of a capacitive touch panel constantly under water. Furthermore, in order to enable the capacitive touch panel to be normally operational both above and under water, the present invention proposes the following method with reference to FIG. 6. First, the control circuit 12/42 is preset to be in a first state. In the first state, a conventional capacitive sensing method is executed while inserting a temporal underwater scanning operation at intervals (Step 61). The conventional capacitive sensing method performs common non-underwater capacitive sensing. For dealing with occasional cases that capacitive touch sensing operation is to be performed when the panel is dipped into water or covered with water drops, the control circuit 12/42 executes at least one underwater scanning whenever a period of time passes. The underwater scanning is any of the sensing methods described above. After the control circuit 12/42 performs at least one scanning over the entire panel using the sensing method of the present invention, whether any finger touch occurs is determined (Step 62). If it is determined that there is no finger touch, return to Step 61 to continue sensing. On the other hand, if occurrence of finger touch is determined in a certain entire-panel scanning, it indicates that a user is operating the panel while it is currently in an underwater environment or a humid environment. Therefore, a second state is entered to proceed underwater scanning (Step 63). Subsequently, whether no finger touch has been sensed for a period of time (for example, 10 seconds) is determined (Step 64). If so, i.e. no finger touch, then it is switched from the second state back to the first state. In this way, the change between the two kinds of environments can be effectively dealt with.

For understanding the details of the above-mentioned capacitive sensing technology, please refer to the contents of specifications of Taiwanese Patent Publication No. 201443754, which is published on 2014 Nov. 16, and entitled “Method and Device for Sensing Control Point on Capacitive-Type Panel”, and Chinese Patent Publication No. CN 104142766, which is published on 2014 Nov. 12. In particular, FIG. 8 of the Chinese Patent Publication No. CN 104142766 and its relevant text describes in detail regarding how to use an external capacitor and a comparator to estimate a voltage difference between two electrodes. The descriptions provide the reference for the above-mentioned control circuit to measure the voltage difference between the two separate sensing electrodes.

To sum up, the present invention has been disclosed in the above embodiments, but it is not intended to limit the present invention. A person skilled in the art can make various changes and modifications without departing from the spirit and scope of the invention. Therefore, the scope of the invention is defined by the scope of the appended claims.

What is claimed is:

1. A position-sensing method for use with an object to be sensed, a first group of electrodes and a second group of electrodes, the position-sensing method comprising steps of:
issuing a driving signal to the first group of electrodes;
selecting at least a first electrode and a second electrode from the second group of electrodes, and performing an electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and
estimating a relative position of the object to be sensed to the first electrode and to the second electrode according to the first electric value and the second electric value generated in the electric property measuring operation.

2. The position-sensing method according to claim 1, wherein the first group of electrodes and the second group of electrodes are formed on a sensing panel, the first group of electrodes extend in a first direction, and the second group of electrodes extend in a second direction and cross over the first group of electrodes within the sensing panel, and wherein the method further comprising steps of: issuing a driving signal to the second group of electrodes; selecting at least a third electrode and a fourth electrode from the first group of electrodes, and performing another electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and estimating a relative position of the object to be sensed to the third electrode and to the fourth electrode according to the third electric value and the fourth electric value generated in the another electric property measuring operation.

3. The position-sensing method according to claim 1, wherein the second group of electrodes are formed on a sensing panel, the second group of electrodes cross over the first group of electrodes outside the sensing panel, and the second group of electrodes are allocated as an array on the sensing panel and essentially formed of the same single electrode layer, and have a shape of square or regular hexagon.

4. The position-sensing method according to claim 1, wherein the first electric value is either a voltage value or a capacitance value, the second electric value is either a voltage value or a capacitance value, and the driving signal is a driving voltage signal.

5. A position-sensing device for sensing a position of an object to be sensed, the position-sensing device comprising:
a first group of electrodes;
a second group of electrodes crossing over the first group of electrodes; and
a control circuit coupled to the first group of electrodes and the second group of electrodes, wherein the control circuit issues a driving signal to the first group of electrodes, selects at least a first electrode and a second electrode from the second group of electrodes, and performs an electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and the control circuit estimates a relative position of the object to be sensed to the first electrode and to the second electrode according to the first electric value and the second electric value generated in the electric property measuring operation.

6. The position-sensing device according to claim 5, wherein the first group of electrodes and the second group of electrodes are formed on a sensing panel, the second group of electrodes cross over the first group of electrodes within the sensing panel, and the control circuit further executes steps of:
issuing a driving signal to the second group of electrodes;
selecting at least a third electrode and a fourth electrode from the first group of electrodes, and performing another electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and
estimating a relative position of the object to be sensed to the third electrode and to the fourth electrode according to the third electric value and the fourth electric value generated in the another electric property measuring operation.

7. The position-sensing device according to claim 5, wherein the second group of electrodes are formed on a sensing panel and allocated as an array on the sensing panel, and the second group of electrodes cross over the first group of electrodes outside the sensing panel, are essentially formed of the same single electrode layer, and have a shape of square or regular hexagon.

8. The position-sensing device according to claim 5, wherein the first electric value is either a voltage value or a capacitance value, the second electric value is either a voltage value or a capacitance value, and the driving signal is a driving voltage signal.

9. The position-sensing device according to claim 5, wherein the second group of electrodes are formed on a sensing panel and allocated as a network on the sensing panel, and the second group of electrodes cross over the first group of electrodes outside the sensing panel.

10. A position-sensing device for sensing a position of an object to be sensed, the position-sensing device comprising:
a first group of electrodes;
a first driving electrode crossing over and capacitive coupling to the first group of electrodes;
a second group of electrodes crossing over the first group of electrodes; and
a control circuit issuing a driving signal by way of a capacitive coupling of the first driving electrode to the first group of electrodes, selecting at least a first electrode and a second electrode from the second group of electrodes, and performing another electric property measuring operation, wherein a plurality of electrodes being in a floating state exist between the first electrode and the second electrode, and the first electrode and the second electrode respectively generate a capacitive coupling effect to the object to be sensed and generate a first electric value and a second electric value in response to the driving signal; and the control circuit estimates a relative position of the object to be sensed to the first electrode and to the second electrode according to the first electric value and the second electric value generated in the another electric property measuring operation.

11. The position-sensing device according to claim 10, wherein the first group of electrodes and the second group of electrodes are formed on a sensing panel, the second group of electrodes cross over the first group of electrodes within the sensing panel, the first driving electrode crosses over the first group of electrodes outside the sensing panel, a second driving electrode crosses over the second group of electrodes outside the sensing panel, and the control circuit further executes steps of:
issuing a driving signal by way of a capacitive coupling of the second driving electrode to the second group of electrodes;
selecting at least a third electrode and a fourth electrode from the first group of electrodes, and performing an electric property measuring operation, wherein a plurality of electrodes being in a floating state exist between the third electrode and the fourth electrode, and the third electrode and the fourth electrode respectively generate a capacitive coupling effect to the object to be sensed and generate a third electric value and a fourth electric value in response to the driving signal; and
estimating a relative position of the object to be sensed to the third electrode and to the fourth electrode according to the third electric value and the fourth electric value generated in the electric property measuring operation.

12. The position-sensing device according to claim 10, wherein the first electric value is either a voltage value or a capacitance value, the second electric value is either a voltage value or a capacitance value, and the driving signal is a driving voltage signal.

13. A state-switching method, comprising steps of:
executing the position-sensing method as recited in claim 1 at intervals, and determining whether a touch action occurs in a first state;
switching the first state into a second state when it is determined that the touch action occurs, and continuing to execute the position-sensing method as recited in claim 1; and
switching the second state back into the first state if no touch action has been sensed in the second state for a certain period of time.
